(19) United States
(12) Patent Application Publication
(10) Pub. No.: US 2024/0182117 A1
(43) Pub. Date: Jun. 6, 2024

(54) Panel with Segmented Features

(71) Applicant: Apple Inc., Cupertino, CA (US)

(72) Inventors: David E Kingman, San Francisco, CA (US); Albert J Golko, Saratoga, CA (US)

(21) Appl. No.: 18/488,914

(22) Filed: Oct. 17, 2023

Related U.S. Application Data
(60) Provisional application No. 63/430,152, filed on Dec. 5, 2022.

(51) Int. Cl. B62D 25/06; B60J 1/00; B60J 1/02; B60J 3/00

(52) U.S. Cl. CPC B62D 25/06; B60J 1/001; B60J 1/02; B60J 3/00

(57) ABSTRACT

A system may include an exterior canopy that extends from a front of a body to a rear of the body. The canopy may include a layer of glass. Different feature layers may be coupled to different regions of the layer of glass. Window layers may each be coupled to the different feature layers. The feature layers and window layers may form three regions, such as a windshield, roof glass, and backlite. Each region may include unique features, such as lighting, display, tinting, and/or haze features. Some of the feature layers may be adjustable by control circuitry in the system. Material may be included between the window layers and the different feature layers to fill any gaps. For example, trim and/or a masking layer may be used to match the appearance between the different regions.

This application claims the benefit of U.S. provisional patent application No. 63/430,152, filed Dec. 5, 2022, which is hereby incorporated by reference herein in its entirety.

### FIELD

This relates generally to transparent structures, and, more particularly, to windows.

### BACKGROUND

Glass structures may be used in a variety of systems. The glass structures may form windows or other desired portions of the systems.

### SUMMARY

A vehicle may include an exterior canopy that extends from a front of the vehicle to a rear of the vehicle. The canopy may also extend from a first side of the vehicle to a second side of vehicle. The canopy may include a layer of glass, such a monolithic layer of glass, or laminated panes of glass.

Different feature layers may be coupled to different regions of the layer of glass. Window layers may each be coupled to the different feature layers. The feature layers and window layers may form three regions, such as a windshield, roof glass, and backlite. Each region may include unique features, such as lighting, display, tinting, and/or haze features. Some of the feature layers may be adjustable by control circuitry in the vehicle. In this way, a continuous canopy structure may be included on the exterior of the vehicle, while individual regions with different appearances and/or functionality are included in the interior of the vehicle.

Material may be included between the window layers and the different feature layers to fill any gaps. For example, trim and/or a masking layer may be used to fill the gaps. By filling the gaps with suitable material, the appearance between the different regions may be matched, and the regions may have a seamless appearance within the vehicle.

### BRIEF DESCRIPTION OF THE DRAWINGS

FIG. 1 is a cross-sectional top view of an illustrative system in accordance with some embodiments.

FIG. 2 is a cross-sectional side view of an illustrative system in accordance with some embodiments.

FIG. 3 is a cross-sectional side view of an illustrative window having multiple segmented features and having an outer laminated glass layer in accordance with some embodiments.

FIG. 4 is a cross-sectional side view of an illustrative window having multiple segmented features and formed from a single outer glass layer in accordance with some embodiments.

FIG. 5 is a cross-sectional side view of an illustrative window having multiple segmented features separated by a masking layer in accordance with some embodiments.

FIG. 6 is a top view of an illustrative window having multiple segmented features in accordance with some embodiments.

### DETAILED DESCRIPTION

A system such as a vehicle may have glass structures, such as canopy structures. For example, a vehicle may have a vehicle body and a single-piece canopy structure that extends from a front portion of the vehicle body to a rear portion of the vehicle body. In particular, the single-piece canopy structure may extend over the areas conventionally covered by a windshield, a backlite, and the top portion of the vehicle. By extending the single-piece canopy structure from the front of the vehicle to the rear of the vehicle, a single-piece glass structure may provide a continuous, seamless appearance as opposed to conventional separate structures.

In some embodiments, it may be desirable to provide different features on different portions of the single-piece glass structure. For example, it may be desirable to incorporate lighting, tinting, haze, display, defrosting, or other features in only some of the portions of the single-piece glass structure. Therefore, the vehicle may have a single-piece glass structure in an exterior region and separate glass structures in the interior region forming multiple regions. Different features may be incorporated into each of the regions. Trim and/or opaque masking layers may be interposed between the regions to hide gaps between the regions. In this way, the vehicle may have an external single-piece canopy and multiple regions with different features and a seamless appearance in the interior.

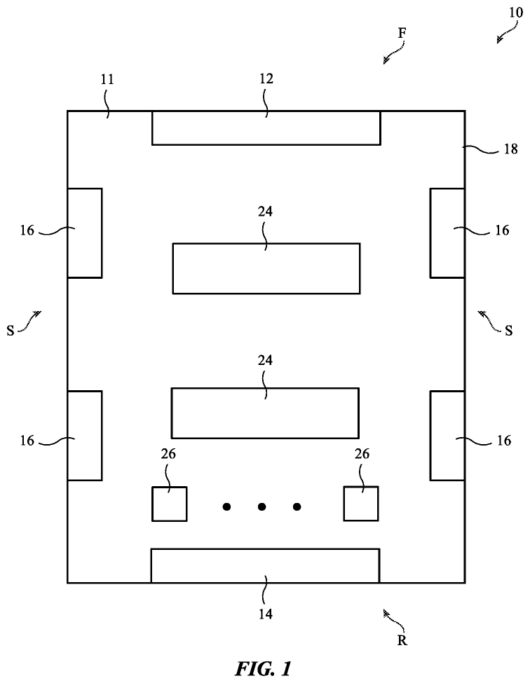

In general, an external single-piece canopy (or single-piece window) with multiple internal regions with different features may be incorporated into any desired system, such as a building or a vehicle. FIG. 1 is a cross-sectional top view of an illustrative vehicle to which a single-piece canopy structure may be applied. In the example of FIG. 1, vehicle 10 is the type of vehicle that may carry passengers (e.g., an automobile, truck, or other automotive vehicle).

Vehicle 10 may be manually driven (e.g., by a human driver), may be operated via remote control, and/or may be autonomously operated (e.g., by an autonomous vehicle driving system implemented using the control circuitry, sensors, and other components of vehicle 10). If desired, a vehicle driving system (e.g., a computer-assisted driving system that is also optionally used to support fully autonomous driving) may be used to provide vehicle driving assistance functions while vehicle 10 is being driven under manual control.

Vehicle 10 may include a body such as body 18. Body 18 may include vehicle structures such as body panels formed from metal and/or other materials, may include doors, a hood, a trunk, fenders, a chassis to which wheels are mounted, a roof, etc. Windows 16 may be formed in doors on the sides S of vehicle body 18, or in other desired portions of vehicle 10, such as on a roof of vehicle 10. Windshield 12 may be formed at front F, and backlite 14 (also referred to as rear window 14 herein) may be formed at rear R of vehicle 10, if desired. Windows 16, windshield 12, rear window 14, doors in body 18, and other portions of body 18 may separate interior region 11 of vehicle 10 from the exterior environment that is surrounding vehicle 10 (exterior region 13).

Vehicle 10 may have seating such as seats 24 in interior region 11. Seats 24 may include bucket seats, bench seats, and/or other seats on which vehicle occupants may sit. These seats may include forward-facing seats and/or rear-facing seats. In the example of FIG. 1, seats 24 include a pair of face-to-face seats 24 in which first and second seats 24 face each other. However, this is merely illustrative. In general, seats 24 may face any desired directions.

Vehicle 10 may be provided with one or more input-output components. These components may include displays, speakers, interior and exterior lights, actuators for adjusting the position and motion of structures in vehicle 10, and input devices that gather user input. The input devices may include proximity sensors, touch sensors, force sensors, buttons, etc. Sensors may also be used in vehicle 10 to make measurements on environmental conditions (e.g., ambient light levels, temperatures, etc.). In some configurations, the input-output components may contain wireless circuitry. The wireless circuitry may include ultrawideband (UWB) circuitry, near-field communications circuitry, Bluetooth® circuitry, wireless local area network circuitry, and/or other wireless circuitry. The wireless circuitry may be used to detect nearby devices (e.g., wireless key fobs, portable electronic devices such as wristwatches and cellular telephones emitting UWB signals and/or other short-range wireless signals, etc.). As an example, wireless circuitry may be used to detect the presence of a nearby electronic device and vehicle 10 may, in response, use an actuator to unlock a door in vehicle 10.

During operation, user input may be used to operate vehicle 10. The input-output components of vehicle 10 may include buttons, sensors, steering components (e.g., a steering wheel and steering system), pedals (e.g., an accelerator and brake pedal), and/or other components that serve as controllers for gathering user input to adjust vehicle operations. These input devices may be used for receiving user steering commands, for receiving user navigation commands for an autonomous driving system, for receiving user input to adjust lighting, media playback, heating and air-conditioning, for receiving input to open and close doors (and windows), for receiving input to lock and unlock doors (and windows), for receiving input to otherwise control doors and/or windows, for receiving input to control other vehicle operations, and for receiving other user input. In an illustrative configuration, vehicle 10 includes sensor circuitry (e.g., a touch sensor, force sensor, proximity sensor, and/or other sensor(s)) to receive commands from users (e.g., vehicle occupants, users approaching vehicle 10 from the outside, etc.). The sensor circuitry may, as an example, include sensors that allow a user to supply user input that directs one or more electrically adjustable actuators to move a door from a stowed to a deployed position, to open and/or close the door, to lock/unlock the door, to open and/or close a window, etc.

As shown in FIG. 1, vehicle 10 of FIG. 1 may include components 26. Components 26 may include control circuitry and input-output devices. Control circuitry and/or input-output devices in components 26 may be configured to operate vehicle systems such as the steering and propulsion system based on user input, to operate vehicle systems such as the steering and propulsion system autonomously in connection with running an autonomous driving application, to run a navigation application (e.g., an application for displaying maps on a display), to run software for controlling vehicle climate control devices, lighting, media playback, window movement, door operations, seating position devices, and/or to support the operation of other vehicle functions. The control circuitry and/or input-output devices (sensor circuitry, other input-output components, etc.) may include processing circuitry and storage and may be configured to perform operations in vehicle 10 using hardware (e.g., dedicated hardware or circuitry), firmware and/or software. Software code for performing operations in vehicle 10 and other data is stored on non-transitory computer readable storage media (e.g., tangible computer readable storage media) in the control circuitry. Remote storage and other remote-control circuitry (e.g., circuitry on remote servers, etc.) may also be used in storing the software code. The software code may sometimes be referred to as software, data, program instructions, computer instructions, instructions, or code. The non-transitory computer readable storage media may include non-volatile memory such as non-volatile random-access memory, one or more hard drives (e.g., magnetic drives or solid-state drives), one or more removable flash drives or other removable media, or other storage. Software stored on the non-transitory computer readable storage media may be executed on the processing circuitry of components 26 and/or the processing circuitry of remote hardware such as processors associated with one or more remote servers that communicate with components 26 over wired and/or wireless communications links. The processing circuitry may include application-specific integrated circuits with processing circuitry, one or more microprocessors, a central processing unit (CPU) or other processing circuitry.

The input-output components (input-output devices) of components 26 may include displays, sensors, buttons (e.g., sensors based on movable button members that press against switches), light-emitting diodes and other light-emitting devices for providing interior and/or exterior lighting, haptic devices, speakers, door locks, actuators for moving portions of doors, windows, and/or other components, and/or other devices such as input devices for gathering environmental measurements, information on vehicle operations, and/or user input. The sensors in components 26 may include ambient light sensors, touch sensors, force sensors, proximity sensors (e.g., optical proximity sensors and/or capacitive proximity sensors based on self-capacitance sensors and/or mutual capacitance sensor circuitry), optical sensors such as cameras operating at visible, infrared, and/or ultraviolet wavelengths (e.g., fisheye cameras and/or other cameras), capacitive sensors, resistive sensors, ultrasonic sensors (e.g., ultrasonic distance sensors), microphones, three-dimensional and/or two-dimensional images sensors, radio-frequency sensors such as radar sensors, lidar (light detection and ranging) sensors, door open/close sensors, seat pressure sensors and other vehicle occupant sensors, window sensors, position sensors for monitoring location, orientation, and movement, speedometers, satellite positioning system sensors, and/or other sensors. Output devices in components 26 may be used to provide vehicle occupants and others with haptic output (e.g., force feedback, vibrations, etc.), audio output, visual output (e.g., displayed content, light, etc.), and/or other suitable output. Components 26 may be mounted in interior region 11 and/or an exterior region outside of body 18 and/or may, if desired, be attached to and/or mounted to other portions of body 18.

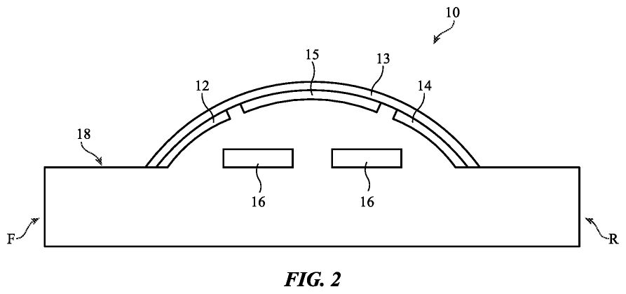

If desired, windshield 12 and rear window (backlite) 14 may be formed by a single-piece, continuous sheet of glass that extends over the top of the vehicle (e.g., may form a roof structure for the vehicle). In other words, the single-piece, continuous sheet of glass (also referred to as a single-piece canopy herein) may cover interior region 11, including seats 24 and components 26, and may also form windshield 12 and backlite 14. The canopy may extend continuously from an outermost edge of windshield 12 to an outermost edge of backlite 14, as an example. The sheet of glass may also extend between the two sides S of vehicle 10. In addition to having a single-piece canopy structure, it may be desirable to include different functionality (e.g., features) in different regions of the canopy structure. Therefore, multiple regions may be formed having different features. An illustrative side view of a vehicle having a single-piece canopy with different regions is shown in FIG. 2.

As shown in FIG. 2, single-piece canopy 13 may extend from a region at front F of vehicle body 18 to a region at rear R of vehicle body 18, and may be coupled to vehicle body 18 between front F and rear R. Canopy 13 may also extend between the sides of vehicle body 18, if desired. In particular, single-piece canopy 13 may be form an external surface of vehicle 10. Windows 16 (e.g., side windows of the vehicle) may be formed below canopy 30 on the sides of vehicle 10, if desired.

Single-piece canopy 13 may have a constant radius of curvature or a non-constant radius of curvature along an axis that extends between front F and rear R and/or along an axis that extends between the sides of vehicle 10. In some embodiments, canopy 13 may have a non-constant radius, such as having a smaller radius at the front and the rear (e.g., the areas conventionally occupied by the windshield and backlite) and a larger radius at the top of vehicle 10. In general, however, the curvature of canopy 13 may be varied in any desired manner along the length (and/or width) of single-piece canopy 13. Canopy 13 may be formed by roll-forming or another suitable process.

Canopy 13 may be formed from a large piece of curved glass. For example, canopy 13 may have an area of at least 5 m², at least 6 m², at least 7 m², or other suitable area to extend between the front and rear of a vehicle and between the sides of the vehicle to create a single-piece canopy structure.

Moreover, to create a single-piece and continuous canopy 13, canopy 13 may require complex curvature. In an illustrative example, canopy 13 may have a first curvature in the area traditionally occupied by a windshield, a second curvature in the area traditionally occupied by a roof of the vehicle, and a third curvature in the area traditionally occupied by a backlite. The first, second, and/or third curvatures may be the same, or may vary from one another. For example, the first, second, and/or third curvatures may have different radii of curvature from the other portions of canopy 13. However, these differences in curvature are merely illustrative. In general, canopy 13 may have any desired curvature.

Canopy 13 may have a strain (e.g., geometric strain) of 12% or less, 15% or less, 10% or less, 7% or less, or 5% or less, as examples. In other embodiments, canopy 13 may have a geometric strain of less than 20%, approximately 20%, less than 30%, or between 18% and 25%, as examples.

In addition to forming single-piece, continuous canopy 13 on an exterior of vehicle 10 it may be desirable to have different regions of canopy 13 with different features, such as tinting, lighting, displays, haze, or other features. In some embodiments, individual glass layers 12, 14, and 15 may be incorporated in an interior of vehicle 10 (e.g., on an inner surface of canopy 13) to form a windshield, backlite, and roof glass, respectively. Although glass layers 12, 14, and 15 are shown as having curvatures that match the curvature of canopy 13, this is merely illustrative. In general, glass layers 12, 14, and 15 may be curved (or have planar portions), as desired.

Different features may then be incorporated between each of glass layers 12, 14, and/or 15 and canopy 13 to create different regions on canopy 13. In some examples, heavy tinting, haze, and/or lighting (e.g., ambient lighting for the interior of vehicle 10) features may be incorporated between roof glass 15 and canopy 13 to reduce the transmission in an upper region of vehicle 10. Similarly, lighter tinting may be incorporated between windshield 12 and canopy 13 and/or backlite 14 and canopy 13. In some embodiments, lighting may be incorporated between backlite 14 and canopy 13, such as to convey messages to passengers inside vehicle 10 or to people outside of vehicle 10 (e.g., a brake light may be incorporated between backlite 14 and canopy 13). However, these examples are merely illustrative. In general, any desired features may be formed in any of the regions formed by windshield 12, backlight 14, and/or roof glass 15.

As shown in FIG. 2, canopy 13 may extend from an outermost edge of windshield 12 to an outermost edge of backlite 14. Moreover, canopy 13 may extend between sides of vehicle 10. However, this arrangement is merely illustrative. In general, canopy 13 may extend over any desired portion of windshield 12, backlite 14, and/or roof glass 15.

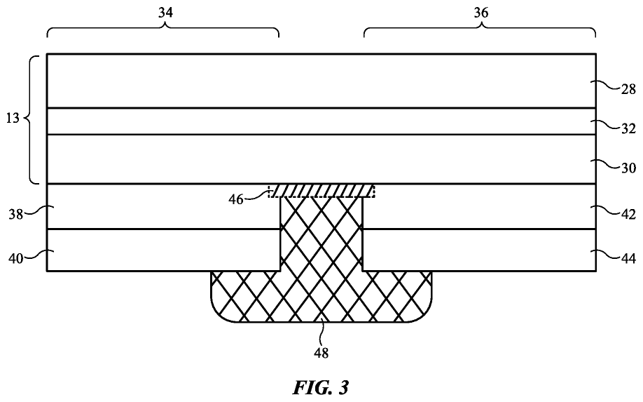

Regardless of which features are incorporated in which regions, the features may be interposed between at least one of glass 12, 14, and 15, and canopy 13. A cross-sectional side view of an illustrative feature interposed between canopy 13 and one of the glass members is shown in FIG. 3.

As shown in FIG. 3, canopy 13 may be formed from laminated layers. In particular, canopy 13 may be formed from first layer 28 and second layer 30 that are laminated using bonding layer 32. First and second layers 28 and 30 may be glass or may be polymer, plastic, ceramic, or other desired material. Bonding layer 32 may be formed from polyvinyl butyral (PVB) or another desired bonding layer.

In some embodiments, it may be desirable to form regions 34 and 36 with different features, such as different appearances or functionality. For example, region 34 may correspond to a windshield region or a backlite region, while region 36 may correspond to a roof glass region. In general, however, regions 34 and 36 may be formed in any desired portions of vehicle 10.

To incorporate desired functionality in region 34, feature layer 38 may be incorporated between canopy 13 (e.g., inner layer 30 of canopy 13) and layer 40. Layer 40 may be a glass layer or may be formed from polymer, plastic, ceramic, or other desired material. If region 34 corresponds with a windshield, layer 40 may be windshield 12 (FIG. 2). Alternatively, if region 34 corresponds with a backlite, layer 40 may be backlite 14 (FIG. 2).

Feature layer 38 may include, for example, a tint layer having at least 90% transmission of visible light, at least 95% transmission of visible light, at least 97% transmission of visible light, or other suitable transmission of visible light. In some embodiments, feature layer 38 may include an active tint layer that can be adjusted between different modes having different transmission levels, such as by control circuitry within vehicle 10. Alternatively or additionally, feature layer 38 may include one or more displays (such as liquid crystal displays, organic light-emitting diode (OLED) displays, microLED displays, or other desired displays that display images on layer 40), a defrosting layer (e.g., heating elements that may defrost canopy 13 and glass layer 40 when activated), or lighting layers. The light layers may be external lighting layers, such as brake light layers, that convey information to people outside of vehicle 10 or may be internal lighting layers, such as ambient lighting layers, that provide ambient lighting to in the interior of vehicle 10. However, these features that may be incorporated into feature layer 38 are merely illustrative. In general, any desired number of features may be incorporated into feature layer 38, either in single layers or in multiple layers. Additionally, any features incorporated within feature layer 38 may extend partially or entirely over layer 40.

To incorporate desired functionality in region 36, feature layer 42 may be incorporated between canopy 13 (e.g., inner layer 30 of canopy 13) and layer 44. Layer 44 may be a glass layer or may be formed from polymer, plastic, ceramic, or other desired material. If region 36 corresponds with a roof glass, layer 44 may be roof glass 15 (FIG. 2).

Feature layer 42 may include, for example, a tint layer having less than 90% transmission of visible light, less than 75% transmission of visible light, less than 60% transmission of visible light, or other suitable transmission of visible light. In some embodiments, feature layer 42 may include an active tint layer that can be adjusted between different modes having different transmission levels, such as by control circuitry within vehicle 10. Alternatively or additionally, feature layer 42 may include one or more displays (such as liquid crystal displays, organic light-emitting diode (OLED) displays, microLED displays, or other desired displays that display images on layer 44), a defrosting layer (e.g., heating elements that may defrost canopy 13 and glass layer 44 when activated), or lighting layers. The lighting layers may be internal lighting layers, such as ambient lighting layers, that provide lighting to people within vehicle 10, as an example. However, these features that may be incorporated into feature layer 42 are merely illustrative. In general, any desired number of features may be incorporated into feature layer 42, either in single layers or in multiple layers. Additionally, any features incorporated within feature layer 42 may extend partially or entirely over layer 44.

Although feature layers 38 and 42 are shown in regions 34 and 36, this is merely illustrative. If desired, some regions of vehicle 10 may not have integrated feature layers. For example, roof glass 15 and backlite 14 (FIG. 2) may have integrated feature layers, while windshield 12 does not. However, this arrangement is merely illustrative. Any desired regions of canopy 13 may have integrated features. If a region does not have integrated features, it may be desirable to include a transparent layer in place of the integrated feature layer to ensure that all of the regions have the same thicknesses. However, the layer may be omitted entirely, if desired.

As shown in FIG. 3, trim 48 may be provided between regions 34 and 36 on interior surfaces of layers 40 and 44 to fill a gap between the two regions. The gap may be at least 2 mm, 4 mm, less than 10 mm, at least 3 mm, or other suitable size. Trim 48 may be formed from plastic or other desired polymer, metal, rubber, or any other desired material. In addition to trim 48, optional masking layer 46 may be provided between canopy 13 and feature layers 38 and 42. Masking layer 46 may be included to have an appearance off-axis (e.g., if a user views masking layer 46 at a high angle with respect to trim 48) and may generally have any desired appearance. In illustrative examples, masking layer 46 may be a black masking layer formed from ink or dye, or may have colored ink or dye to impart a desired color, such as blue, white, or gray, or a desired pattern. However, masking layer 46 may be omitted, if desired.

In some embodiments, trim 48 may have an index of refraction that is matched with the index of refraction of regions 34 and 36 (e.g., the index of refraction of layers 40 and 44). For example, trim 48 may have the same index of refraction as one or both of layers 40 and 44, or trim 48 may have an index of refraction that is between the index of refraction of layers 40 and 44. In some embodiments, if layers 40 and 44 have different refractive indexes, trim 48 may have a graded index from the refractive index of layer 40 to the refractive index of layer 44. In other words, trim 48 may have the same refractive index as layer 40 at an edge that is adjacent to layer 40, may have the same refractive index as layer 44 at an edge that is adjacent to layer 44, and may have a graded index between the two edges. However, this is merely illustrative. In general, trim 48 may have any suitable refractive index to create a desired appearance. In general, by incorporating trim 48 (and optionally masking layer 46), the gap between regions 34 and 36 may be hidden, and there may be a seamless appearance between the two regions both from the exterior and interior of the vehicle.

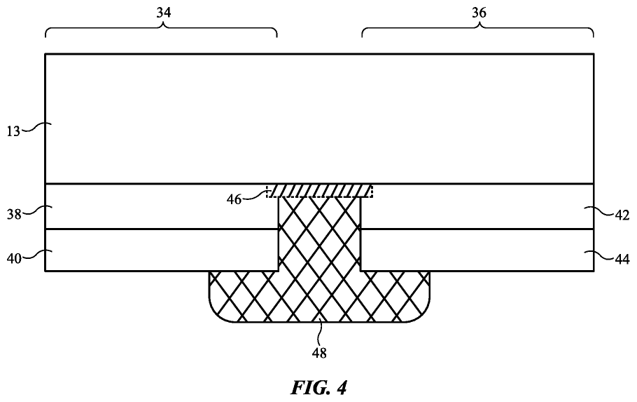

Although canopy 13 has been described as being formed from laminated layers, this is merely illustrative. Canopy 13 may be formed from a single layer, such as from a monolithic layer of glass or other material, if desired. An illustrative example in which canopy 13 is formed from a single layer is shown in FIG. 4. As shown in FIG. 4, canopy 13 is formed from a single layer. Regions 34 and 36 are then formed on canopy 13 using feature layers 38 and 42 (as well as layers 40 and 44), respectively, as described in connection with FIG. 3. Trim 48 and optional masking layer 46 may fill the gap between regions 34 and 36.

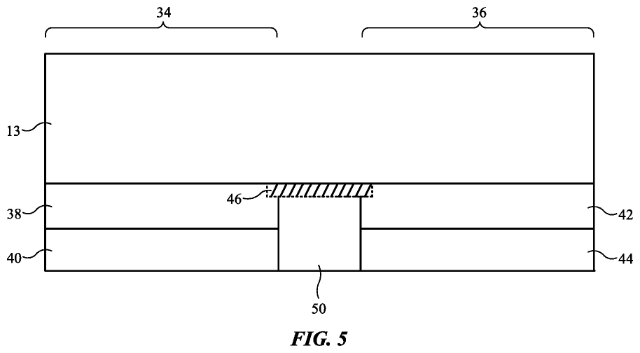

Regardless of whether canopy 13 is formed as a laminated layer or as a single, monolithic layer, masking layer 46 may be included or omitted as desired. Additionally, trim 48 may be omitted in some embodiments. An illustrative embodiment in which trim 48 is omitted is shown in FIG. 5.

As shown in FIG. 5, regions 34 and 36 may be formed on canopy 13 as described in connection with FIGS. 3 and 4. However, instead of having trim 48 between regions 34 and 36, masking layer 46 may match the appearances of regions 34 and 36. For example, masking layer 46 may be a black masking layer, or a layer of a different color, to create a seamless appearance between regions 34 and 36. Additionally, to fill the physical gap between layers 38 and 40 and layers 42 and 44, transparent material 50 may be incorporated in the physical gap. Transparent material 50 may be, for example, a filler material such as epoxy, optically clear adhesive, or other desired transparent filler material. Alternatively, material 50 may have a desired color to match masking layer 46 and/or to create a desired appearance between regions 34 and 36. In some embodiments transparent material 50 may have an index of refraction that matches the index of refraction of regions 34 and 36 (e.g., the index of refraction of layers 40 and 44). In this way, regions 34 and 36 may have a seamless appearance. In some embodiments, if layers 40 and 44 have different refractive indexes, material 50 may have a graded index from the refractive index of layer 40 to the refractive index of layer 44. In other words, material 50 may have the same refractive index as layer 40 at an edge that is adjacent to layer 40, may have the same refractive index as layer 44 at an edge that is adjacent to layer 44, and may have a graded index between the two edges. However, this is merely illustrative. In general, material 50 may have any suitable refractive index to create a desired appearance.

Although trim 48 and material 50 have been described as filling the gap between regions 34 and 36, this is merely illustrative. One or both of trim 48 and material 50 may be omitted, if desired.

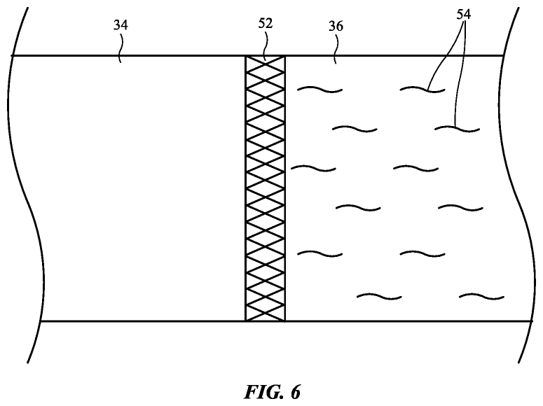

Whether trim or filler material is included or omitted between the different regions, the feature layers in each region may impart a different appearance or functionality. A top view showing illustrative regions with different appearances is shown in FIG. 6.

As shown in FIG. 6, regions 34 and 36 may be separated by material 52. Material 52 may correspond with trim 48 of FIGS. 3 and 4, and/or may correspond with masking layer 46 of FIGS. 3-6. Region 34 may have a first appearance, such as being more transparent, while region 36 may have a second appearance, such as being less transparent. As indicated by lines 54, region 36 may have increased tint and/or haziness as compared with region 34. In some embodiments, region 34 may be a windshield or a backlite with high transparency (such as over 90% transparency), while region 36 may be a roof glass with low transparency (such as less than 80% transparency). Regions 34 and 36 may incorporate active tint and/or active haze layers to adjust the transparency or haziness of the regions, if desired.

Alternatively or additionally, region 36 may have other features, such as lighting, such as ambient lighting or informational lighting (e.g., brake lighting), one or more displays that display images within region 36, and/or defrosting functionality. Region 34 may also have one or more features, if desired.

Although regions 34 and 36 have been described as being regions of a canopy that extends from the front to a rear of a vehicle, this is merely illustrative. Canopy 13 may extend from one side of a vehicle to another side of the vehicle, or regions 34 and 36 may be incorporated in a non-vehicular system, such as a building. Alternatively or additionally, regions 34 and 36 may be formed in a windshield (e.g., a windshield that extends along the vehicle in the direction of travel from a plane defining the front row of seats inside the vehicle to a plane forward of the front lights (e.g., headlights) of the vehicle), a backlite, a canopy, a transparent portion (e.g., a windshield) that is curved at the front of the vehicle to extend to cover the A pillar on the driver and/or passenger side of the vehicle, a transparent vehicle body portion and/or side windows of a vehicle, or windows of a building. In general, any suitable transparent structure in a vehicle may have two or more regions 34 and 36, and may have trim or filler material to fill the gaps between the regions.

The foregoing is merely illustrative and various modifications can be made to the described embodiments. The foregoing embodiments may be implemented individually or in any combination.

What is claimed is:

1. A vehicle having an interior and an exterior, comprising:
a canopy at the exterior, wherein the canopy comprises a layer of glass;
a first feature layer coupled to the layer of glass in a first region;
a first window layer coupled to the first feature layer;
a second feature layer coupled to the layer of glass in a second region;
a second window layer coupled to the second feature layer, wherein the second window layer is separated from the first window layer by a gap; and
material that fills the gap between the first window layer and the second window layer.

2. The vehicle of claim 1, wherein the first window layer is a roof glass and wherein the first feature layer comprises a tint layer.

3. The vehicle of claim 2, wherein the tint layer has a transmission of less than 75% of visible light.

4. The vehicle of claim 2, wherein the tint layer is an active tint layer having an adjustable transmission.

5. The vehicle of claim 2, wherein the second window layer is a backlite, the vehicle further comprising:
a third window layer coupled to the canopy in a third region, wherein the third window layer is separated from the first window layer by an additional gap.

6. The vehicle of claim 5, wherein the third window layer is a windshield, the vehicle further comprising:
a third feature layer interposed between the third window layer and the canopy, wherein the third feature layer comprises a tint layer with at least 90% visible light transmission.

7. The vehicle of claim 6, wherein the third window layer is a windshield and wherein the canopy extends from an outermost edge of the windshield to an outermost edge of the backlite.

8. The vehicle of claim 1, wherein the material comprises trim that fills the gap and that partially extends over the first and second window layers.

9. The vehicle of claim 8, further comprising:
a masking layer in the gap and interposed between the trim and the canopy.

10. The vehicle of claim 1, wherein the material comprises transparent filler material, the vehicle further comprising:
a masking layer in the gap and interposed between the transparent filler material and the canopy.

11. The vehicle of claim 1, wherein the layer of glass that forms the canopy is a monolithic layer of glass.

12. The vehicle of claim 1, wherein the canopy further comprises an additional layer of glass that is laminated to the layer of glass, and wherein the layer of glass is interposed between the additional layer of glass and the first and second feature layers.

13. The vehicle of claim 1, wherein the layer of glass of the canopy is a continuous layer of glass that has an area of at least 5 m² and a geometric strain of less than 20%.

14. A vehicle having an interior and an exterior, comprising:
a canopy at the exterior;
first and second feature layers coupled to the canopy in first and second respective regions, wherein the first and second feature layers are separated by a first gap;
first and second glass layers respectively coupled to the first and second feature layers, wherein the first and second glass layers are separated by a second gap that overlaps the first gap; and
trim that at least partially fills the first and second gaps.

15. The vehicle of claim 14, further comprising:
a third feature layer coupled to the canopy in a third region; and
a third glass layer coupled to the third feature layer.

16. The vehicle of claim 15, wherein the first glass layer forms a windshield, the second glass layer forms a roof glass, and the third glass layer forms a backlite.

17. The vehicle of claim 16, wherein the first feature layer comprises a tint layer, the second feature layer comprises an internal lighting layer, and the third feature layer comprises an external lighting layer.

18. The vehicle of claim 14, wherein the first glass layer forms a roof glass, and wherein the first feature layer comprises a lighting layer configured to provide ambient lighting to the interior.

19. A vehicle, comprising:
a continuous layer of glass that forms a canopy;
a first feature layer coupled to the continuous layer of glass;
a first glass layer coupled to the first feature layer, wherein the glass layer forms a roof glass; and
a second glass layer coupled to the continuous layer of glass, wherein the second glass layer forms a windshield or a backlite.

20. The vehicle of claim 19, further comprising:
a second feature layer interposed between the second glass layer and the continuous layer of glass; and
trim that fills a gap between the first glass layer and the second glass layer.
